(19) United States
(12) Patent Application Publication
(10) Pub. No.: US 2009/0050697 A1
(43) Pub. Date: Feb. 26, 2009

(54) Apparatus for distributed data storage of security identification and security access system and method of use thereof

(76) Inventors: Collier Sparks, Helotes, TX (US); Tim Rohrbach, San Antonio, TX (US); James Oakley Lowder, Helotes, TX (US)

Correspondence Address: George R. Schultz;Schultz & Associates, P.C., One Lincoln Centre, 5400 LBJ Freeway, Suite 1200, Dallas, TX, 75240, US

(21) Appl. No.: 11/895,436

(22) Filed: Aug. 24, 2007

(51) Int. Cl. G06K 7/01

(52) U.S. Cl. 235/382.5

(57) ABSTRACT

An apparatus and method are provided to control the entry and tracking of individuals into and through controlled areas for security. A novel system is provided which stores data in a collection of portable data carriers of various formats and flash memory. A method is further provided to control the so called “anti-passback” of individuals into controlled areas. Still further provided is a system which allows storage and dissemination of control information for security system operation on the collection of data carriers allowing the intelligence of the reader system to be low compared to the network security systems of the prior art. Controlling data can include data pointers, program components, executable files and various operating systems.

### FIELD OF THE INVENTION

This invention relates to security systems and, in the preferred embodiment, to “smart” data card security systems in which access at a secured location is controlled by a comparison of data on the card with data stored in the system. More particularly, this invention relates to a system in which, in addition to card data, keyboard data may be entered by persons wishing access.

### BACKGROUND

Security systems utilizing remote terminals to limit access at individual remote locations have, in the past, primarily utilized static magnetic card readers at these remote locations for controlling access through electrically operable devices, such as doors, turnstiles, printers, etc. Other technologies have evolved that include proximity cards and touch contact data carriers. Prior art systems have also been devised in which the remote card readers communicate with a central data processor or operate as stand-alone units.

The card data is typically encoded as a plurality of magnetically polarized spots in a sheet of magnetic material. Such encoded data normally includes an identification number or numbers identifying the cardholder. The card or badge bearing encoded data used for controlling access is typically inserted into a slot of a reader which reads and decodes the data on the card. During use, this data encoded on the card is compared with a number or numbers stored in a central computer server in network systems using workstations or at the remote locations. Prior art systems ascertain whether the individual inserting the card is entitled by comparison of an ID number on the card to a database of “allowed” card IDs usually correlated to the identity of the cardholder.

In one prior art system, the magnetically polarized spots are used to directly actuate a read relay or other moving switch mechanism located within the reader. As is exemplified by U.S. Pat. No. 3,686,479 entitled “Static Reader System For Magnetic Cards” to Rogers, et al., electromagnetic solid state sensors are used. Such systems have been found to be reliable but are limited in the capacity of cardholders that can be maintained and in the ability to communicate information when network communications are inoperable.

Other prior art systems have been disclosed which incorporate a central processor which periodically and sequentially polls each of the remote terminals in the system. Such a system is disclosed in U.S. Pat. No. 4,004,134 entitled “Off-Line Magnetic Card Reader System Operable as Though Normally on Line” to Hwang. The remote terminals are able to transfer data to the central processor only on receipt of a polling pulse. At the central terminal, data read at the remote location from an inserted card is compared with a master list which includes those persons who shall be given access at that remote location. Such systems, in the past, have permitted a limited degree of remote terminal operation, even if some or all of the interconnecting lines between the remote terminal and the central processor have been interrupted. The systems, however, generally require that a much simpler test be made of persons wishing entrance during such degraded mode operation, and thus the group of persons allowed access at such times is, of necessity, much larger than would normally be granted access. This is a distinct disadvantage since it does not permit a controlled programmable access under all circumstances as is often required in secured locations.

Another prior art system for providing degraded operation in such a central processor-oriented system is disclosed in U.S. Pat. No. 4,097,727, entitled “Circuit For Controlling Automatic Off-Line Operation of An On-Line Card Reader” to Ulch. In that system, there is no substantial system flexibility regarding the persons who will be granted access during degraded mode operation. It is common in a system of that type to provide access during degraded mode operation to any person having a card coded for use within the overall security system, even if it is not coded for use at this particular remote location.

It has also been known in the prior art to include a keypad for data entry at the remote location. As an example, keyboard system which permits programming after installation, is disclosed and claimed in U.S. Pat. No. 4,142,097, issued Feb. 27, 1979 entitled “Remotely Programmable Keyboard Sequencing For a Security System” to Ulch. Typically the keypad systems require entry of a “PIN” or personal identification number, typically a sequence of digits. The digits have comprised a particular permutation and combination of the data encoded on the card, the particular permutation and combination often being different for different remote terminals.

The prior art also includes the use of an active key or “smart card” such as the disclosure in U.S. Publication No. US2004/0160305A1 entitled “Electronic Access Control System” to Remenih. This disclosure provides a security system that includes an electronic lock and an electronic key. The electronic key holds identification data that notifies the lock of the key's functional type and the locks that the key is authorized to open. In one embodiment, circuitry in the lock checks whether an inserted key holds an access code that is more recent than a corresponding access code stored in the lock, indicating that the data on the inserted key is more current than the data stored in the lock. The lock is then automatically reprogrammed with the data stored in the inserted key. However, Remenih does not address the limit to the storage or the number of cardholders who can access the system or limits imposed by degraded communications.

U.S. Publication No. US2003/0112123 entitled “Method and Apparatus for Providing a Programmable Gate Security System” to Hom discloses an apparatus for activating and reprogramming various features of a security system that relies on a read/write chip that inserts into a socket connected to the control unit of the security system. Depending on the activation codes written onto the chip, when the chip is inserted into its socket, it activates or deactivates various features and parameters of the system. Additionally, the chip can be used to activate certain features of the system. Thus, if a customer desires to upgrade to advanced features of the system this avoids having to install additional features since they having already been built into the system and are activated by insertion of a chip with the appropriate code.

While the systems disclosed in the prior art have provided workable security networks, certain persistent problems have remained unsolved. One of these problems involves the fact that systems utilizing a central server invariably provide very broadly based access during degraded communication line operation or no access at all. In addition, the prior art systems in which remote workstations are used to store lists of identification numbers are limited in size, thereby limiting the number of cardholders that can be accommodated.

Traditional systems are also limited by the speed of the host server and workstation. For every cardholder using the system, the computer must search the entire database which includes all authorized individuals and their entry codes to confirm if the cardholder is authorized. Therefore, the larger the number of cardholders contained in the database, the more search time is required. The prior art has compensated for this problem by increasing the speed and expense of the computers used. However, these are practical limits to the speed and cost of attainable systems.

Another problem in the security industry created by the use of access cards is called “pass back”. Pass back is a situation where a person uses their access card or code to enter a door and then “pass back” their card to someone outside the building for them to use to gain access. In order to prevent this situation, “anti-pass back” techniques are needed to prevent two people from using the same means of unlocking the same door while both individuals are in the building.

Another problem in the security industry created by the use of large databases of information related to cardholders is physical and data security of that database. If a global list of cardholders and associated information is stored in a single location for comparison, even logically on different drives, there exists a risk of discovery by unauthorized cardholders which cannot be avoided.

### SUMMARY OF THE INVENTION

The present invention includes a system for secure access control comprising a controller having a unique identifier; a controllable access portal in communication with the controller; a reader in communication with the controller, a data card, removably connectable to the reader, for storing the unique identifier, and the controller programmed to upload the unique identifier from the data card, check the validity of the unique identifier and open the controllable access portal upon confirmation.

The present invention also includes a system for controlling access to controlled areas comprising a first programmable controller having a first unique identifier and a first key access connector, a first controllable lock operatively connected to the first controller, a second programmable controller having a second unique identifier and a second key access connector, a second controllable lock operatively connected to the second controller, a first access key removably connectable to the first key access connector and the second key access connector and having a first readable memory programmed with the first unique identifier and the second unique identifier and wherein the first programmable controller is programmed to read the first readable memory and identify the first unique identifier, and open the controllable lock to allow access to the controlled areas upon identification of the first unique identifier.

The present invention also includes a method of verifying the access authorization of an access card comprising the steps of presenting the access card to a controller having a unique GUID, uploading a GUID list from the access card to the controller, receiving a decision from the controller as to the presence of the GUID on the GUID list, not blocking access authorization if the GUID is on the GUID list, and blocking access authorization if the GUID is not on the GUID list.

### BRIEF DESCRIPTION OF THE DRAWINGS

A better understanding of the present invention can be obtained when the following detailed description of one exemplary embodiment is considered in conjunction with the following drawings, in which:

FIG. 1 is a schematic diagram of a prior art physical access control system.

FIG. 2 is a schematic diagram of a wide area network controller in communication with local area controllers in disparate locations as provided by a preferred embodiment of the invention.

FIG. 3 is a schematic diagram of the computer server utilized for the wide area network controller in a preferred embodiment of the invention.

FIG. 4a is a schematic diagram of a locally controlled physical access security system as provided by a preferred embodiment of the present invention.

FIG. 4b is an alternate embodiment of the invention incorporating standalone controllers.

FIG. 5a is a schematic diagram of a computer utilized for the local network controller in a preferred embodiment of the invention.

FIG. 5b is a schematic diagram of a single board computer utilized for the local network controller in a preferred embodiment of the invention.

FIG. 6 is a schematic diagram of memory sectors of a preferred embodiment of the electronic access card as provided by the current invention.

FIG. 7a is a flowchart of the method employed by a local network controller configured with a sequel database used in conjunction with an XML file stored in an electronic access card.

FIG. 7b is a flowchart of a local network controller configured to operate with a memory mapped electronic access card.

FIG. 8 is a flowchart of the method employed by a controller of a preferred embodiment of the invention.

FIG. 9a is a schematic diagram showing the implementation of a path taken by a cardholder through a secure facility.

FIG. 9b is a memory map of the tracking sector of the preferred embodiment of an electronic access card of the invention showing a LIFO stack.

FIG. 9c is a memory map of the tracking sector of the preferred embodiment of the electronic access card of the invention showing a FIFO stack.

FIG. 10a is a top view of the preferred embodiment of the physical package of the electronic access card of the invention.

FIG. 10b is a bottom view of the preferred embodiment of the physical package of the electronic access card of the invention.

FIG. 11 is a schematic diagram showing the implementation of the “anti-pass back” feature of the invention.

FIG. 12 is a flowchart of a method employed by a local area controller to monitor and grant access of a cardholder employing the anti-pass back feature of the invention.

### DETAILED DESCRIPTION OF THE INVENTION

In the description that follows, like parts are marked throughout the specification and drawings with the same reference numerals, respectively. The drawing figures are not necessarily drawn to scale and certain figures may be shown in an exaggerated or generalized form in interest of clarity and conciseness.

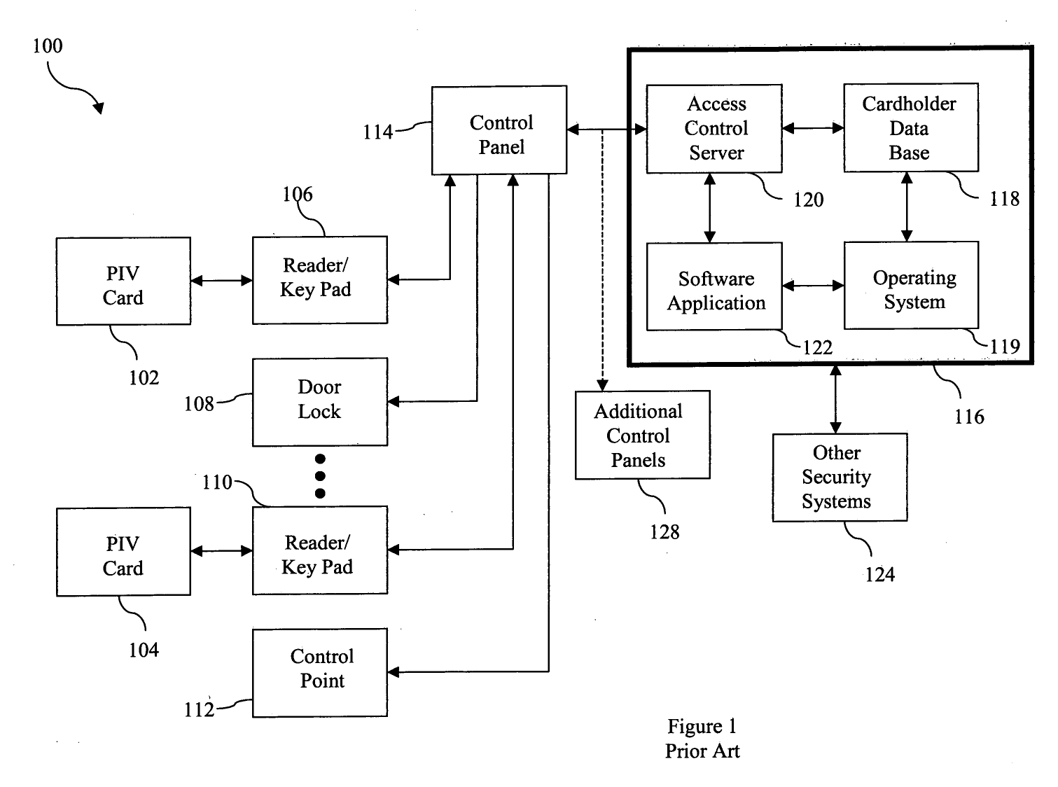

FIG. 1 shows a prior art physical access control system 100. Physical access control system 100 includes a computer system 116. The computer system is usually housed in a physically secure location and monitored for tampering. Computer system 116 usually comprises a single robust server including a cardholder database 118, software application 122, operating system 119 and access control server 120. Cardholder database 118 is usually a database which includes a series of fields storing identifying information related to various authenticated and unauthenticated cardholders such as PIN numbers, fingerprint data, and encryption passwords. The database is typically very large and is stored on large hard drives or optical media. Operating system 119 typically loads from a bootstrap program stored on a hard drive of the system and is specific to the server on which it is running. Software application 122 runs in the operating system environment and usually comprises executable files necessary to access the database, initiate network communication and run various applications necessary to the functioning of the physical access control system. Cardholder database 118 and software application 122 are held in data communication with access control server 120. Access control server 120 is typically a proprietary hardware and software system which allows network communication with control panel 114, additional control panels 128 and other security systems 124. The communications protocol is normally proprietary to each specific system. Other security systems 124 comprise video positioning systems, audio control systems, legacy systems and systems such as perimeter control and matrix switchers. Control panel 114 is typically a proprietary hardware system which uses a proprietary protocol to communicate information to and receive information from access control server 120. Control panel 114 also typically uses a proprietary protocol to communicate information to and receive information from reader/key pad 106, door lock 108, reader/key pad 110 and control point 112. Reader/key pad 106 and reader/key pad 110 typically comprise an I/O device capable of receiving information from and storing information on data storage cards shown at 102 and 104. Key pads are well known in the art and typically comprise a ten or twelve point alpha numeric and/or Arabic number input system with a display showing information to a cardholder. Door lock 108 is typically a combination of a current supply source, a switch and an electromagnetic or solenoid activated mechanical door lock mechanism. Control point 112 is typically a display screen or other I/O device used to communicate information related to the security system to a cardholder, a guard or a physical barrier.

The card is presented to a card reader to initiate an authentication transaction and requests access authorization. Once the data is read the reader sends the information to the control panel.

The panel is connected to the access control server, card reader/key pad and control point hardware. The control panel receives the information from the card reader and compares it to the data stored in the cardholder database using the software application resident on the server. The server makes the decision as to whether or not to allow access to the holder of the card. The control panel sends the decision to the access control server to be displayed and logged. The door lock receives a signal from the control panel to unlock the door or inform the cardholder that access has been denied. All successful and unsuccessful attempts are typically logged in a database on the server.

If communication is disabled between the control panel and the access control server then a typical default mode is to prevent any access to the system by any cardholder or allow all cardholders access. Obviously, neither is completely satisfactory.

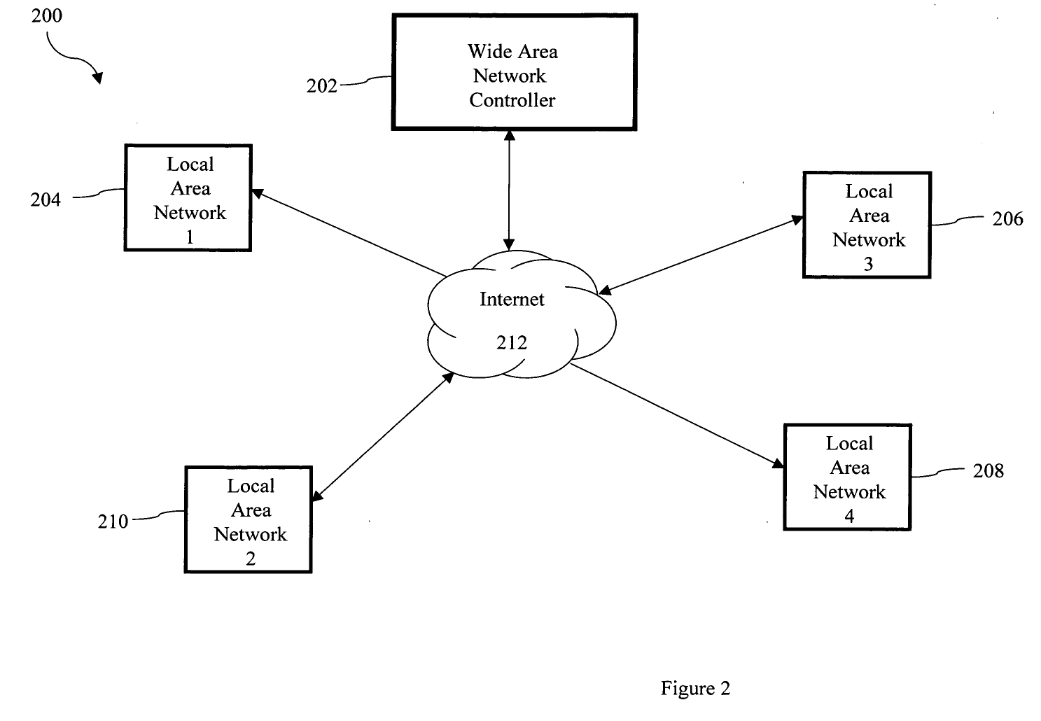

A wide area network implementation of a preferred embodiment of the present invention is shown in FIG. 2. Security system 200 for access control including electronic access cards is shown. Security system 200 includes a wide area network controller 202 connected to Internet 212. Internet 212 in turn is connected to geographically distinct local controllers 204, 210, 206 and 208 for areas 1-4, respectively. Each area includes a local network controller and card reader capable of communicating access control information to wide area network controller 202 through Internet 212. In the preferred embodiment, all communications are made using TCP/IP protocol.

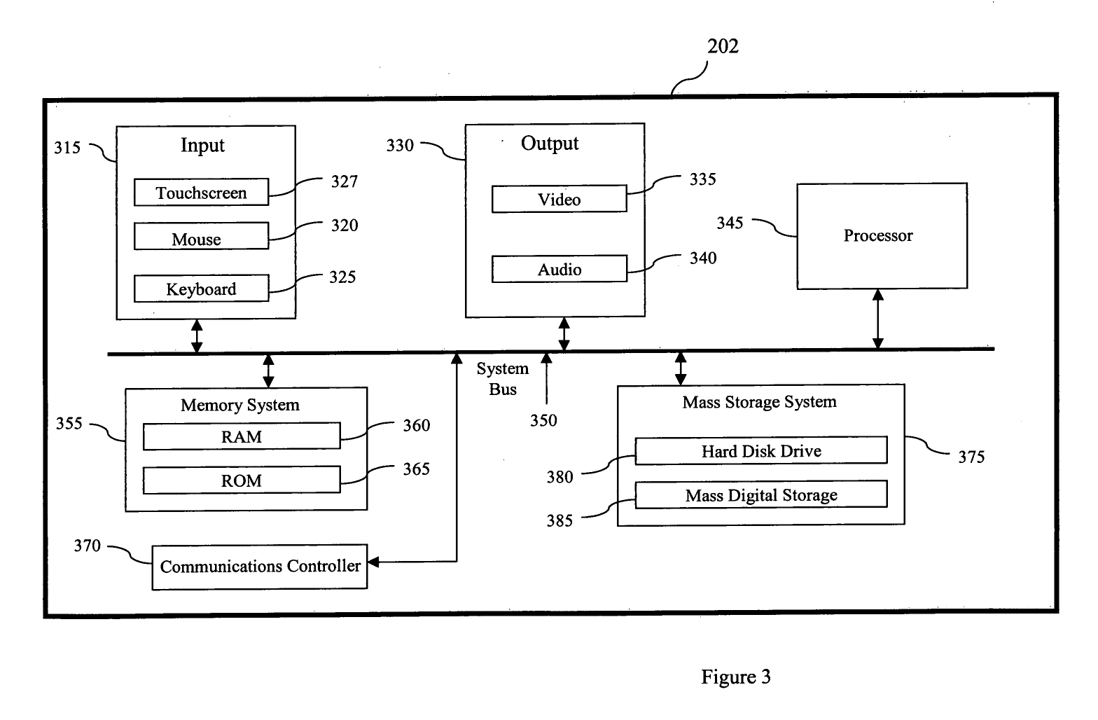

FIG. 3 shows a block diagram of wide area network controller 202. Wide area network controller 202 is typically a computer server fitted with traditional input output devices and network capabilities. Wide area network controller 202 includes input devices 315, including mouse 320, keyboard 325, touch screen 327. Wide area network controller 202 also includes output devices 330, including a video monitor 335 and audio speakers 340. Wide area network controller 202 also includes a microprocessor 345. In the preferred embodiment microprocessor 345 is an Intel Pentium Class machine running a Microsoft Windows Operating System such as Windows 2000.

Wide area network controller 202 in the preferred embodiment also includes applications capable of running sequel databases for efficient storage and retrieval of large amounts of database information. Applications specifically configured for communication of data in XML files are included as well.

Wide area network controller 202 includes a known motherboard physical architecture including daughter boards connected to system bus 350 to drive memory system 355 and mass storage system 375. Memory system 355 includes random data access memory 360 and read only memory 365. Read only memory 365 includes typical bootstrap instructions to operate the controller on startup and allow it to load and run applications stored in the mass storage system.

Communications controller 370 is also connected to system bus 350 and is responsible for network communications. Mass storage system 375 includes hard disk drive 380 and mass digital storage 385. In another preferred embodiment, mass storage system 375 also includes mass digital storage capabilities.

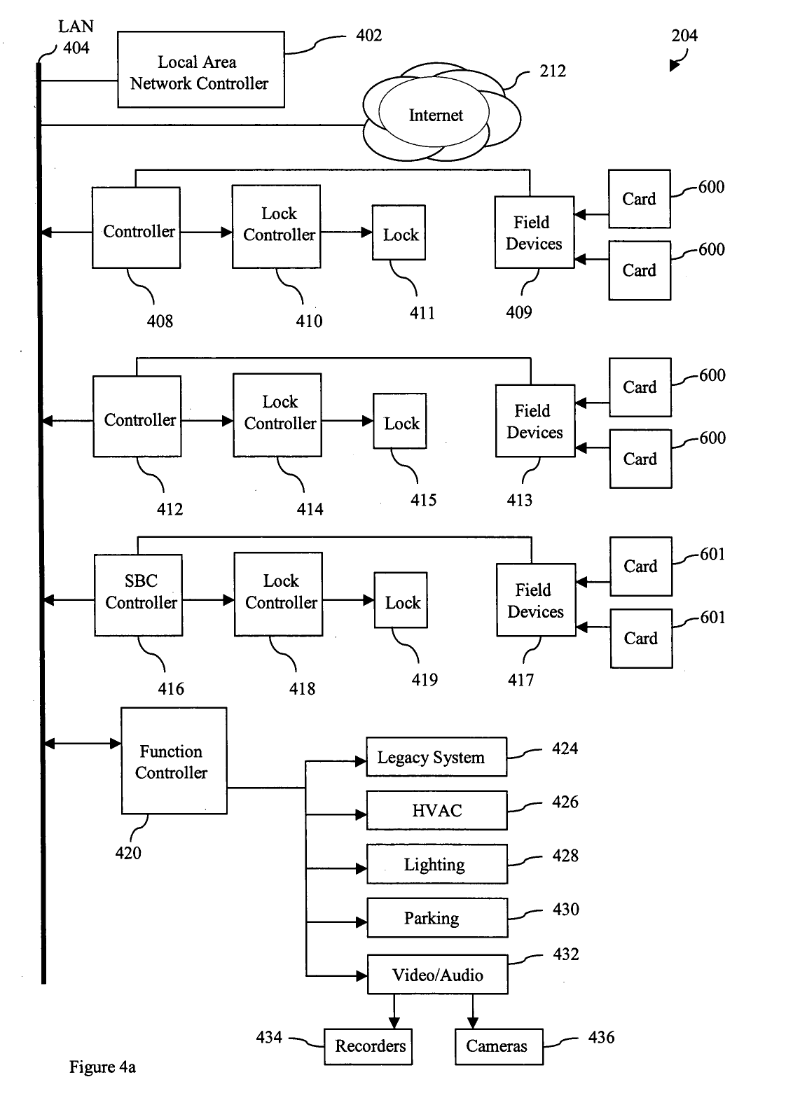

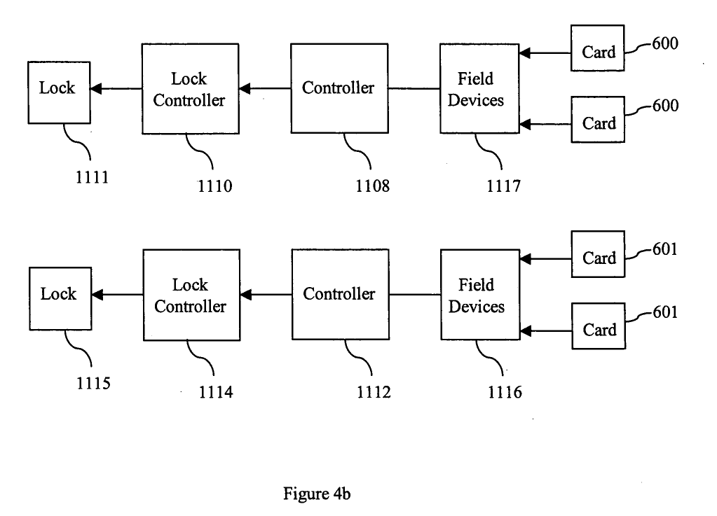

Moving to FIG. 4a, a block diagram is shown of a local area network including components arranged to carry out the features of the invention. Those skilled in the art will recognize that the architecture is only an example. Different architectures from that shown are capable of supporting the method of the invention.

Local Area Network Controller 402 in the preferred embodiment is a workstation fitted with the same devices and capabilities as the wide area network controller. For brevity, the detailed description will not be repeated.

Local network controller 402 is connected to Ethernet LAN 404. Ethernet LAN 404 is in turn connected to controller 408, controller 412, SBC controller 416 and function controller 420.

Controllers 408 and 412 are connected to lock controllers 410 and 414 and electric door locks 411 and 419, respectively. Field devices 409 and 413 are connected to controllers 408 and 412, respectively. Controller 412, lock controller 414, lock 415 and field devices 413 are identical to controller 408, lock controller 410, electric door lock 411 and field devices 409 but are located in geographically different locations in a secured facility. SBC controller 416, lock controller 418, electric door lock 419 and field devices 417 comprise different physical devices and software applications and may also be located in different geographic locations in the secured facility. Electronic access cards 600 and 601 are presented directly to field devices 409, 413 and 417 respectively. Information loaded on the access cards is uploaded to the field devices and utilized without the controllers having instruction from or reporting to a network.

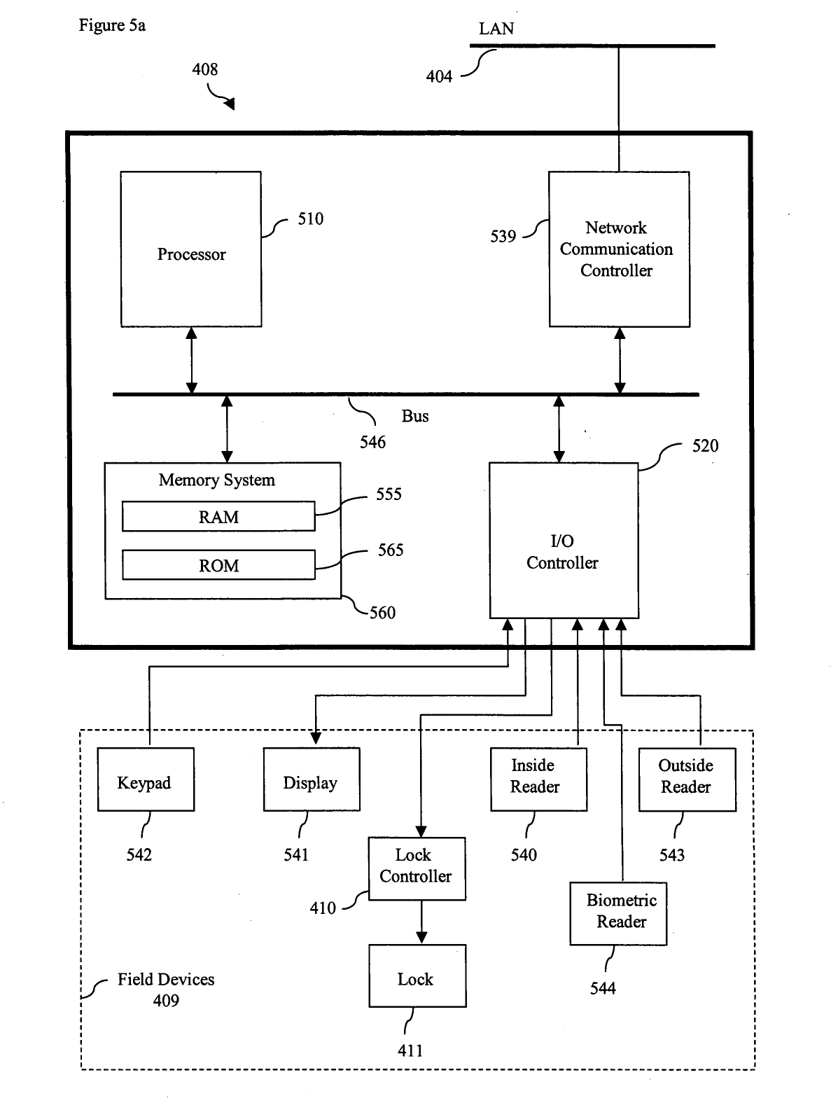

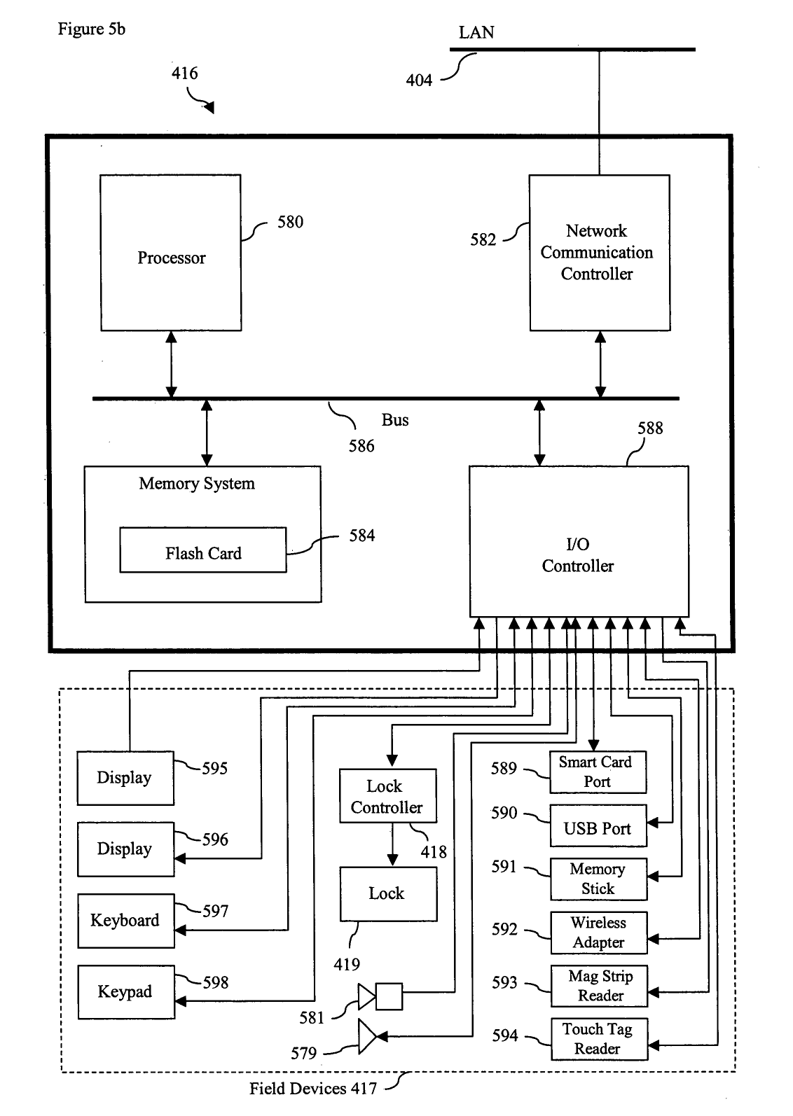

Turning now to FIGS. 4a and 5b, SBC controller 416, lock controller 418 and electric door lock 419 will be described.

SBC Controller 416 includes processor 580, network communication controller 582, memory system 584 and I/O controller 588 connected by bus 586. Processor 580 in this preferred embodiment includes an ARM-9 processor running a Linux operating system. The ARM-9 processor incorporates a 32 bit RISK processor architecture typical of embedded designs. Appropriate processors include the OMAP series available from Texas Instruments, Inc. of Dallas, Tex. The ARM-9 series processors typically operate at 200 MIPS at 180 MHz.

Memory system 584 in this embodiment includes flash card memory for general storage and transfer of data. The compact flash standard is adopted as a physical interface. A compact flash in the preferred embodiment includes a capacity of about 128 megabytes. In another embodiment, memory system 584 can include a microdrive packaged in compact flash type 2 form factor and interface. Microdrives of the preferred embodiment are offered by Hitachi Corporation.

Network communication controller 582 is connected to system bus 586 and is configured to communicate via a 10/100 Mb/s Ethernet adaptor.

I/O controller 588 is configured to communicate with smart card port 589, USB port 590, memory stick port 591, wireless adaptor 592, magnetic strip reader 593 and touch tag reader 594.

Smart card port 589 includes appropriate physical interfaces suitable for connection to high capacity smart cards. In the preferred embodiment, the smart card port is EVM 2000 Level I compliant. Smart card port 589 in the preferred embodiment also complies with the contact standard ISO 7816. In one example of a preferred embodiment, the reader is the high capacity reader model SC3311 offered by SCM Microsystems, Inc. of Fremont, Calif. Another example is the ASC drive III E USB V2 high performance PC/SCUSB smart card reader, available from Athena Smart Card Solutions of Tokyo, Japan. Those skilled in the art will recognize that other smart card readers will also function as well.

USB port 590 in the preferred embodiment is a 4-port hub supported by processor 580, as is known in the art.

Memory stick port 591 in the preferred embodiment is also a typical USB interface for interfacing memory cards such as compact flash cards, secure digital cards and multimedia cards. In the preferred embodiment, the smart card reader implements the USB mass storage device class.

Wireless adaptor 592 in the preferred embodiment complies with smart card communication standards ISO/IEC 14443 for communication through RFID induction technology. The reader is capable of data rates of 104 to 848 kilobits per second with an antenna proximity of approximately 10 cm.

Magnetic strip reader 593 in the preferred embodiment complies with ISO standards 7810, 7811, 7812, 7813 and 4909. Magnetic strip reader 593 communicates with I/O controller 588 through the RS232 standard or the Wigand standard as known in the art.

Touch tag reader 594 is also typically simple contact device adapted to communicate with touch tag data carriers. An example of a touch tag capable of being used with the device is the iButton® DS1991L Multikey available from Dallas Semiconductor of Dallas, Tex. In this embodiment, touch tag reader 594 is a simple stainless steel contact plate with a shielded connection to I/O controller 588.

I/O controller 588 is also responsible for communications with displays 595 and 596, keyboard 597, keypad 598, lock controller 418, and electric door lock 419. I/O controller 588 also includes video inputs for video camera 581 and audio inputs for speaker 579.

In the preferred embodiment, lock controller 418 includes a transistor circuit to receive and isolate a control signal from I/O controller 588. The transistor circuit is coupled to a set of relays which provide sufficient current to engage electric door lock 419. Current is supplied from an independent power supply within lock controller 418. In the preferred embodiment, the control signal from I/O controller 588 is about 5 to 12 volts DC and the control current supplied to the control signal supplied by lock controller 418 to electric door lock 419 is about 24 volts DC. Those skilled in the art will recognize that electric door lock 419 can come in many forms. In the preferred embodiment, electric door lock 419 is an electromagnet positioned adjacent a door frame which when activated prevents the door from opening and is available from Securitron Magnalock Corp. of Sparks, Nev.

Displays 595 and 596 are connected to I/O controller 588. Displays 595 and 596 in one embodiment include a set of LEDs of differing color. The LEDs receive drive current from I/O controller 588 and display simple “access granted” and “access denied” indications to the cardholder of the electronic access card. In another embodiment, displays 595 and 596 can include an LCD matrix display capable of communicating additional information to the cardholder of the electronic access card. For example, the display can communicate that a required “PIN” number or other information must be entered into keypad 598 before access will be granted. In another embodiment, displays 595 and 596 include full size monitors that are also used for displaying information and graphics to the cardholder of the electronic access card or to security supervisors.

Keypad 598 is also connected to I/O controller 588 in controller 416. In one embodiment, keypad 598 includes a 10-key data entry pad for entry of alphanumeric data as required. In other embodiments, keypad 598 can include a touch sensitive screen or full keyboard for entry of required information to allow access by the electronic access cardholder. Those skilled in the art will recognize that keypad 598 and displays 595 and 596 can take several forms depending on the information required to be displayed and received from the cardholder in various embodiments. Keyboard 597 is also provided for more detailed entry of data by the cardholder.

Referring then to FIGS. 4a and 5a, an alternate embodiment is described. Controller 408 comprises a single board computer having a physical backplane structure. The backplane architecture is robust, reliable and well suited to military applications. In this preferred embodiment the backplane is provided with a mixture of slots totaling twenty or less and designed to fit within an nineteen inch rack mount enclosure. In one preferred embodiment, controller 408 is a VME BUS power PC including an IBM PPC 750 processor running at about 500 MHz, with 512 megabytes of SD RAM including a tundra universe 2 bus interface chip with a 10/100 Mb/s Ethernet adaptor (shown as network communications controller 539). In this preferred embodiment, the power PC is also equipped according to military spec mil-std-1553 and is available from SBS Technologies, Inc. of Albuquerque, N. Mex. In other embodiments the controller physical architecture can include non-traditional backplane examples such as PC/104, PC/104-+, PCI-104, EPIC and EBX commonly available for embedded control systems. The Compaq PCI, PXI and VXI architectures are also acceptable.

Each controller is assigned a unique ID number upon system setup. In the preferred embodiment, this number is a globally unique identifier (GUID). The GUID is a 16 byte (128 bit) number stored in hexadecimal form. The format of the GUID is a four byte word, three two byte words and a six byte word sometimes separated by field delimiters. The total number of possible unique GUIDs is on the order of 3.4×10³⁸, therefore it is virtually impossible that any two controllers possess the same GUID.

Controller 408 includes processor 510, network communication controller 539, memory system 560 and I/O controller 520 connected by bus 546. I/O control 520 includes access for keyboards and mouse controllers as well as video and graphics output. Controller 408 includes memory system 560 including random access memory 555 and read only memory 565. Memory in the controller is provided on a series of plug-in cards such as SIMMS and DIMMS which provide no functionality beyond providing memory and in the preferred embodiment are carriers of random access memory chips.

Controller 408 is connected to readers 540 and 543, biometric reader 544 and lock controller 410. Readers 540 and 543 in the preferred embodiment are mechanical adaptors designed to receive the electronic access card and electrically connect it to controller 408. In the preferred embodiment, the readers include a USB “B” connector for downstream connection to a USB “A” connector of an electronic access card. In the preferred embodiment, the reader includes USB connectors which comport with USB 1.0, 1.1 and 2.0 specifications. However, in other embodiments, the connectors are compliant with the IBM Ultraport standard. Reader 540 is also compliant with the USB functional standard. It provides a single nominally 5-volt power supply which can range between 5.25 volts and 4.375 volts and can deliver up to 500 milliamps of power to the electronic access card. The “B plug” is approximately 7×8 millimeters. In the preferred embodiment, the reader is connected to I/O controller 520 through a cable of no greater than 5 meters. In other embodiments, the reader can be a further distance from the controller. However, in this embodiment, a powered hub is required to support power and communications requirements of the USB standard. In the preferred embodiment, biometric reader 544 is a fingerprint scanner sold under the trademark “Fingerlock” and available from AuthenTec Corporation of Melbourne, Fla.

I/O controller 520 is also connected to keypad 542, display 541, lock controller 410 and, electric door lock 411. These devices are similar to those previously described. A description will not be repeated.

One skilled in the art will recognize that the mechanical specifications of the readers can vary depending on the type of electronic access card and physical trait measurement device chosen. If memory cards or other secured digital access cards are chosen for an electronic access card, then the readers necessarily must comply with the mechanical standards in order to carry out its functions of physically receiving the electronic access card and connecting it to I/O controller 520.

Returning to FIG. 4a, function controller 420 is shown connected to the Ethernet LAN 404. Function controller 420 in one embodiment is a computer capable of communication with the various controllers and the Internet. In another embodiment, function controller 420 incorporates large disk drive storage for support of local functions.

Function controller 420 is also connected to legacy system 424, HVAC system 426, lighting controller 428, parking controller 430 and video/audio controller 432. Legacy system 424 in the preferred embodiment is a control system sold under the trademark SafeNet® offered by MDI, Inc. of San Antonio, Tex. The legacy system provides access control as well as control of various video cameral locations and positioning devices and coordinators their uses with high density data storage devices and video recorders. In this embodiment, function controller 420 serves as an interface between network local area network controller 402, the controllers and the legacy system to coordinate their operation.

HVAC system 426 represents the control functions required by a heating, ventilating and air conditioning system of a modern office complex. The heating, ventilating and air conditioning controller provides an interface between the function controller and the HVAC equipment. In modern HVAC controllers, feedback is also provided as to the functions of the HVAC equipment to function controller 420.

Lighting controller 428 is provided in a preferred embodiment to control the lighting in an office complex. The function controller monitors the lighting controller providing instructions to and receiving feedback from lighting controller 428.

Parking controller 430 provides an interface between mechanical gates, raiseable speed bumps, gates and bullards and function controller 420. Other mechanisms pertinent to traffic and parking control are also accessed by parking controller 430. Parking controller 430 provides operational signals and current to the parking control equipment and provides feedback as to their operation to function controller 420. Function controller 420 also provides for the activation of video cameras 436 and video recorders 434 through video/audio controller 432. Function controller 420 also provides position input to video/audio controller 432 with video cameras 436 provided with positioning mechanics to locate and focus their field of view.

Moving to FIG. 4b, in an alternative embodiment of the invention, the controllers, lock controllers, locks and field devices are not connected to a local area network or any network whatsoever. Each is a standalone system. For example, controller 1108 is connected to lock controller 1110, electric door lock 1111 and field devices 1117. Controller 1112 is connected to lock controller 1114, electric door lock 1115 and field devices 1116. Electronic access cards 600 are presented directly to the field devices. Information loaded on the access cards is uploaded to the field devices and utilized without the controllers having instruction from or reporting to a network. In this embodiment, tracking lists, exception lists and other data fields are updated directly on the access cards upon their presentation to the field devices. In embodiments where the controllers are fitted with a bootstrap program, an operating system and a memory, information stored on the access cards can be downloaded and stored on the controllers for distribution to other access cards upon presentation. Similarly, tracking data or pointers, program components and FASC data may all be locally stored on the controllers. As with other embodiments, however, the complete list of GUIDs for each controller, in this example, controller 1108 and controller 1112 is stored on each electronic access card 600. Each controller is individually responsible for allowing or communicating signals to the lock controllers to allow or deny access to the secured areas. Furthermore, updates that are necessary between controller 1108 and 1112 can be carried temporarily by a field in the electronic access card. For example, with respect to the exception list, flags indicating non-functional equipment and system faults and updated GUID lists are but a few examples of the information that can be moved from controller to controller via temporary storage in each electronic access card.

Electronic access card 601 is now described. The electronic access card can take several forms. In the preferred embodiment, electronic access card 601 is a 256 kilobyte double EEPROM embedded smart card, manufactured by Samsung Electronics Company, Ltd., of Tokyo Japan, and is sold under part no. S3CC9EF. The smart card includes 384 kilobytes of read only memory, 8 kilobytes of static RAM and a 16-bit CALMRISC CPU including symmetrical key encryption capabilities.

In the preferred embodiment, the data file structure of the Samsung component is exploited by storing files in XML format. In the preferred embodiment, the XML file includes card identification data, reader list identification data, personal identification information, tracking location information, legacy data and flag data. An example of the XML file stored in the smart card of the preferred embodiment is shown below:

```
    <?XML version = “1.0”?>
    <!doctype keyfile system = “keyfile.dtd”>
    <card id>
        100
    <\card id>
    <reader list>
```

| | | |
|---|---|---|
| HAF1 | 4321 | BCDF 212F |
| 2321 | AB21 | CDFC 212D |
| 40AE | 1234 | DEFA 1AC2 |

| <\reader list> | | |
|---|---|---|
| <time auth> | 0800 1700 | <\time auth> |
| <date auth> | 1025 2008 1025 2009 <\date auth> | |
| <person id> | | |
| <employee id> | 21 | <\employee id> |
| <birthdate> | 11/15/1961 | <\birthdate> |
| <ss>452124525 | <\ss> | |
| <pic data> | 000111000111 | <\pic data> |
| <retina data> | 000111000111 | <\retina data> |
| <fingerprint data> | 000111000111 | <\fingerprint data> |
| <password> | dog | <\password> |
| <security clearance> | secret | <\security clearance> |
| <\person id> | | |
| <tracking location> | room 4 | <\tracking location> |
| <legacy data> | 000111000111 | <\legacy data> |

| | |
|---|---|
| <flag data> | 1 <\flag data> |

The “card id” field stores the randomly assigned card identification number. In this case, the number is 100.

The “reader list” field includes the GUID of each reader that the card is authorized to access. The “time auth” field designates the time during which the card is active. Similarly, the “date auth” field indicates the dates during which the card is active. The “person id” field includes the fields “employee id”, “birthdate”, “social security”, “pic data”, “retina data”, “fingerprint data”, “password” and “security clearance” fields. The “pic data”, “retina data” and “fingerprint data” fields all include data compatible with graphics files used to generate personal identification. The “password” field provides a field for storage of a changeable password. The “security clearance” field provides a field for storage of the cardholder's security clearance.

The “tracking location” field is overridden upon entry of the cardholder into any particular secured location and is available for tracking purposes. The “legacy data” field provides storage for information necessary to operate legacy components such as function controllers for legacy security cameras, pan zoom controllers, as well as other necessary data fields for system compatibility. The “flag data” field is provided for storage of information related to the operational status of controllers at various locations in the network. This flag is set when an electronic access card encounters a controller that has a system fault or other condition that prevents it fully functioning. The flag information is passed via the flag data field and operational controller upon presentation of the electronic access card.

Electronic access card 600 in an alternate embodiment is a USB mass storage device implementing communications protocols defined by the USB Implementers Forum that run on the Universal Serial Bus.

Mechanically, the electronic access card in the alternate embodiment is a USB flash drive implementing the standardized USB mini-A and mini-B mechanical specifications. Advantages provided by the USB physical standard include a robust construction making the connectors safe and easy to be inserted and removed from connectors without damage. The connector can be dropped or crushed without significant damage. Other advantages include the asymmetric configuration which makes the connector difficult to insert incorrectly. Other mechanical advantages include the ability of the device to be gripped by the receiving connector, making the need for other physical connection unnecessary. The connectors are also particularly cheap to manufacture and are widely available.

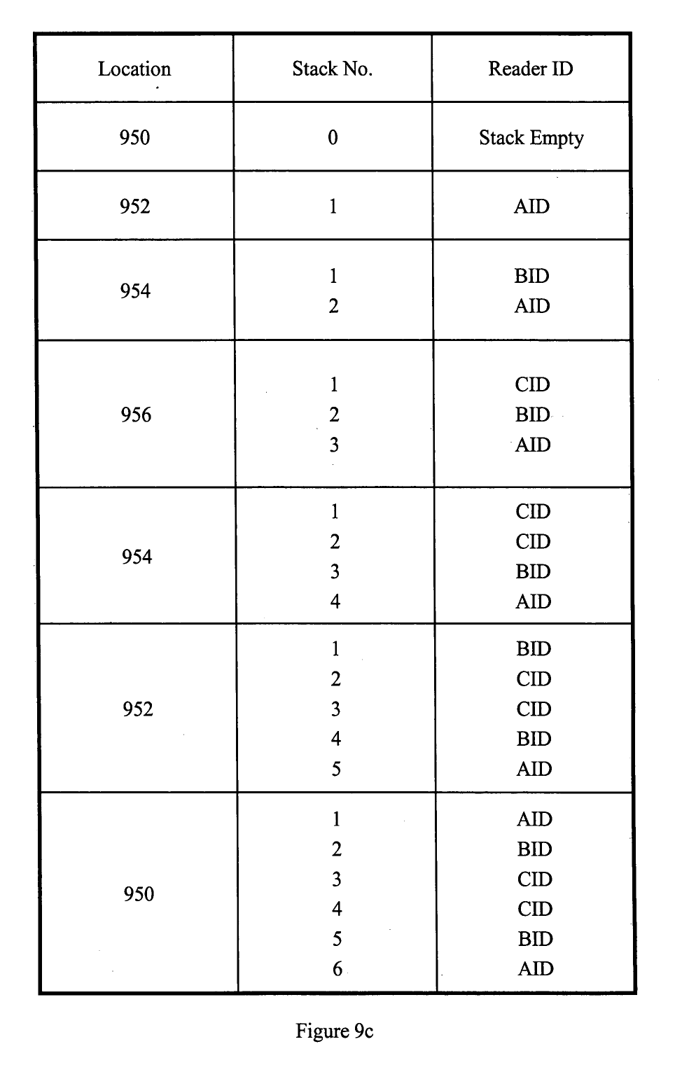

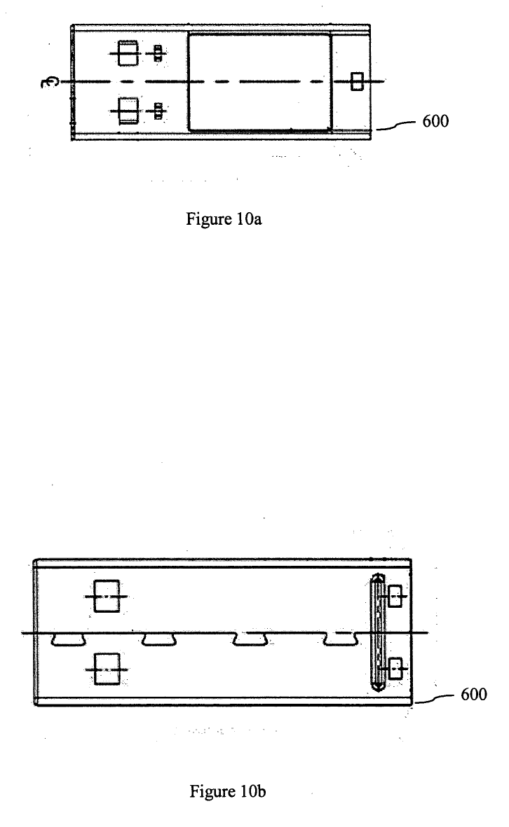

In the preferred embodiment, the mechanical form factor for the USB flash card is a metal encased USB “A” compliant host receptacle with a total length of about 32 mm with a width of about 12 mm and a height of about 4.5 mm. The design is extremely low cost and extremely rugged. The design appears in FIG. 10a and FIG. 10b. The preferred embodiment of the package is available from Lexar Media, Inc. of Fremont, Calif. In another preferred embodiment, a plastic overmold is created to cover the package and add further isolation to the electronics within.

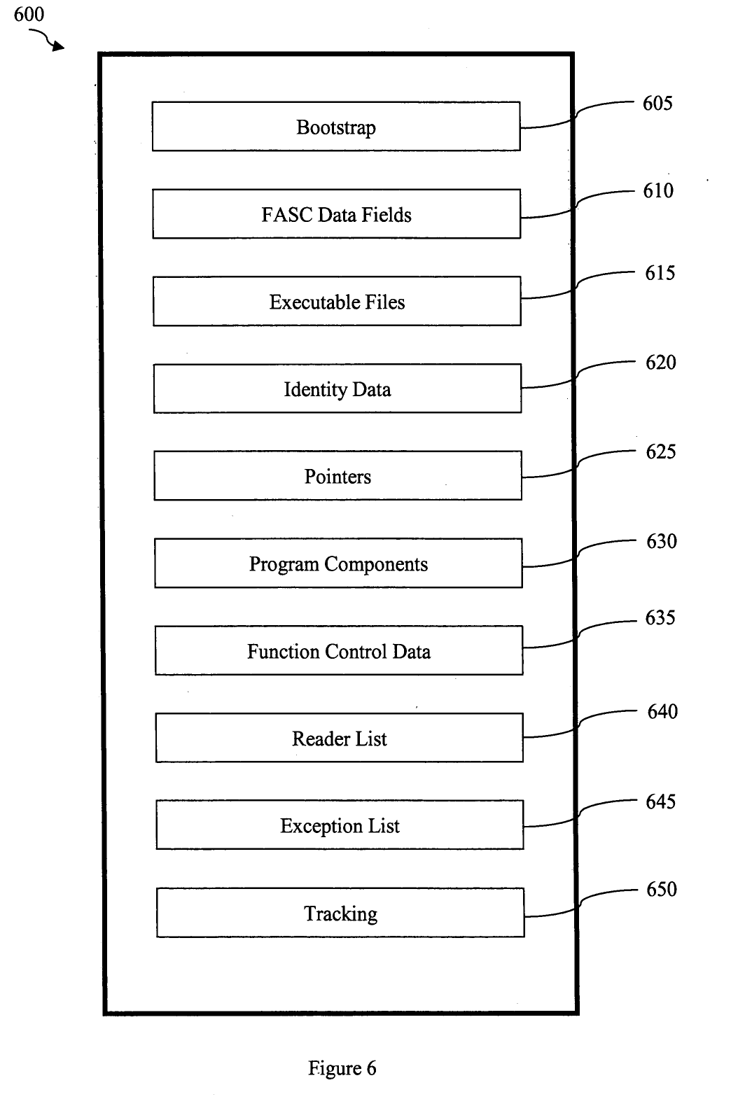

Referring then to FIG. 6, the USB mass storage device memory is mapped to include several sectors. In the preferred embodiment, the sectors include a bootstrap sector 605, FASC data fields sector 610, executable file sector 615, identity data sector 620, pointers sector 625, program component sector 630, function control data sector 635 and reader list segment 640. The data may be formatted with Microsoft FAT, NTSF but may also be formatted using HFS Plus for Apple Macintosh or EXT2 under Linux. Those skilled in the art will recognize that the implementation of file systems embedded on the device makes support for file names and other standards easier but is not necessary for the functioning of the invention.

In other preferred embodiments, the flash drive is loaded with a bootable disk image as opposed to a conventional file system image. In this case, bootstrap sector 605 contains pointer locations and other bios specific information needed by the host computer on boot up.

In the preferred embodiment the electronic access card includes a flash memory which is a form of EEPROM (electrically erasable programmable memory). The flash memory may hold this content without the need of a power supply on board. In the preferred embodiment, flash chip incorporated in the electronic access card is available from Toshiba or Sandisk and is capable of storing 8 gigabits or 1 gigabyte of data. Other alternatives include the 16 and 32 gigabit chips manufactured by Samsung Electronics.

The USB mass storage device typically includes a mass storage controller for implementing the USB host controller and providing an interface to the block oriented data, block erasure and wear balancing. The controller typically includes an RISC microprocessor and a limited amount of ROM and RAM memory. The USB mass storage device also typically includes a NAND flash memory chip and a crystal oscillator which produces the devices 12 MHz clock signal and controls the device's data output through a phase locked loop.

In another preferred embodiment, the flash memory format can be the secured digital (SD) memory card format, as is known and used in portable devices such as digital and hand-held computers. In this preferred embodiment, the multimedia card is available from Canon and works quite well. Those skilled in the art will recognize that the SD format is less open than that for USB flash memory drives and therefore will require an open source wrapper for closed source SD driver available for each particular platform or use of the retired MMC mode of communication supported by the SD standard. The SD standard allows data storage in the 128 gigabyte range using a 28-bit sector address.

FASC data fields sector 610 is provided in the preferred embodiment to comply with the United States Government's required standards for federal identification including standardized agency codes available from the United States government under the title NIST Special Publication 800-87 (SP800-87): Codes for Identification of Federal and Federally Assisted Organizations, dated Aug. 9, 2005. The FASC-N data provides identifiers for government agencies, systems in which the card is enrolled, credential numbers, credential series, individual credential issue, personal identifiers, organizational categories and organizational identifiers required by NIST Special Publication 800-87.

Executable files sector 615 is provided on the electronic access card as storage for various executable files required by the computer control in various embodiments. The executable files can include operating systems, applications for controlling lock controllers, and applications controlling the various functions of function controller 420. Various executable files needed and authorized to be used by the holder of the electronic access card are also stored in this sector.

Identity data sector 620 includes fingerprint data, picture data, personal identification numbers, signature images, retina scanned information, voice print identification information, face recognition, hand geometry and other biometric identifying information. Those skilled in the art will recognize that other data for verifying identity can be stored in this sector. For example, questions to be presented to the keyholder as request data can be stored such as passwords or specific questions (e.g., your mother's maiden name). The answers to the questions are also stored on the card but are not displayed to the cardholder during the query. Rather, the answers are used as a basis of comparison to the data entered by the cardholder. Identity data sector 620 also can include asymmetric or symmetric cryptographic keys for use in encoding or decoding any and all data stored on the electronic access card.

Pointers sector 625 contains information in a tabular form used to identify certain executable or data files resident in the memory of host machine.

Program component sector 630 includes sections of executable code and/or other program components such as object definitions, object plug-ins, design link libraries or other components necessary and used by functioning applications on the host computer.

Function control data sector 635 includes specific instructions to be used by the function controller in operation of legacy systems, a HVC systems or parking systems specific to the holder of the electronic access card.

Reader list sector 640 includes a tabular list of GUIDs for all readers that the particular electronic access card is to be allowed access. In practice, the reader list corresponds to a designation of physical areas to which the electronic access card should be granted access.

Exception list sector 645 is provided in the electronic access card to provide for the movement of data downloaded from the host machine to the electronic access card and correspondingly to other host machines when read by the reader. In practice this sector is used to move information physically from one reader and host machine to another in circumstances when network communication is not possible.

Tracking sector 650 is provided to store information about the readers that have granted or denied access to the electronic access card. In practice, the information in the tracking sector is used to locate an electronic access card within a building or set of secured areas without the need for remote storage of tracking information on a network drive.

Those skilled in the art will recognize that the memory locations of the preferred embodiment of electronic access card 600 can be incorporated into an XML file as described in relation to electronic access card 601 as well.

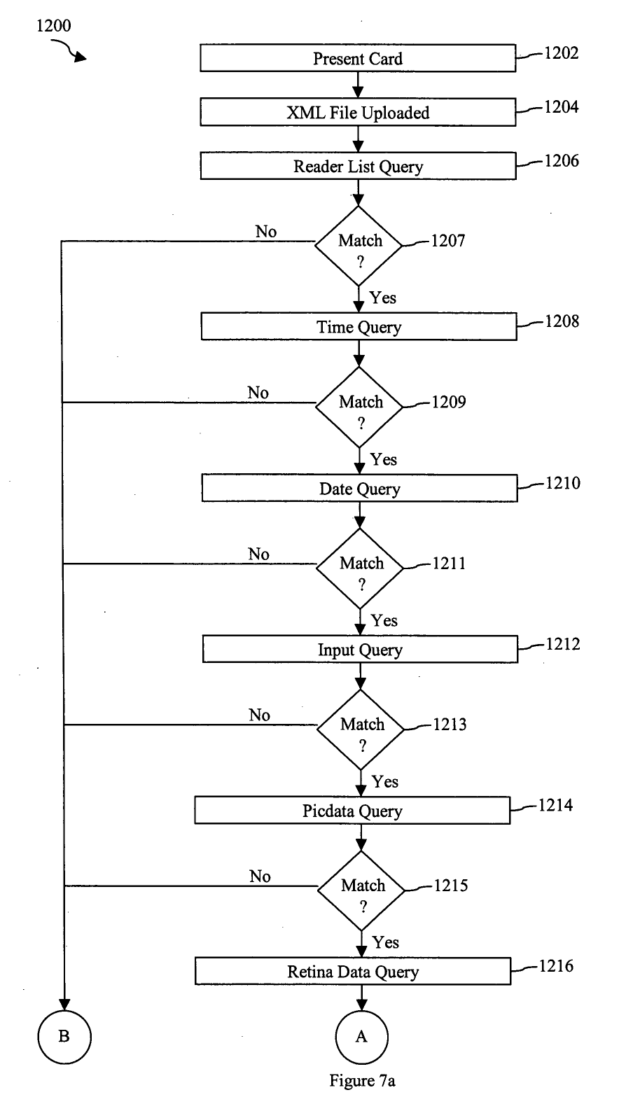

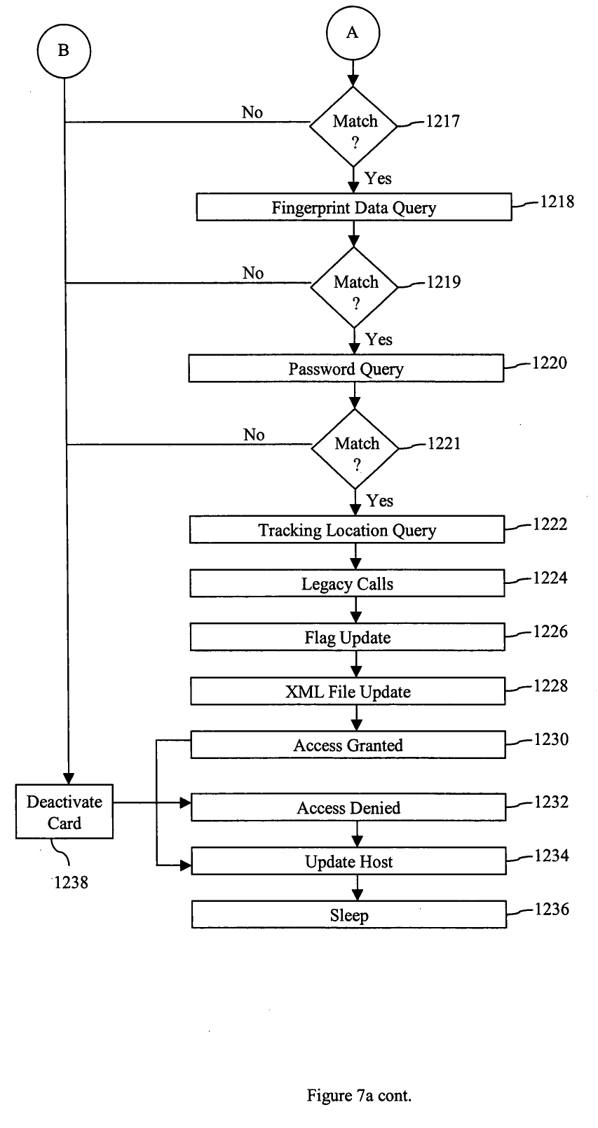

FIG. 7a shows a flowchart of the access request routine 1200 executed by a controller in a preferred embodiment of the invention employing a smart card storage device as the electronic card 601 and a host server running an SQL database application. In step 1202, the card is presented to a compatible smart card reader. The entire XML file is uploaded by the controller and queries are submitted to the database using standard SQL format at step 1204. The reader list is uploaded and queried against the GUID for the particular controller at step 1206. If equivalent, a query is sent for the next data field at step 1207. If not, the card is deactivated at step 1238. At step 1208, the time authorization field is queried against the local clock time on the controller. If the clock time on the local controller is within the time authorized, the next query is made at step 1209. If not, the card is deactivated at step 1238. At step 1210, the date authorization field is queried against the date read from the controller's onboard processor. If within the appropriate parameters, the next query is made at step 1211. If not, the card is deactivated at step 1238. At step 1212, an input query is made comparing data input through a keypad or other I/O device by the cardholder and compared against any of the employee ID, social security, password and/or security clearance data stored in the appropriate fields. Those skilled in the art will recognize that, of course, other fields can be stored and compared against data input by the cardholder. If the query condition is satisfied at step 1213, the processor proceeds to the “pic data” query 1214. If not, the card is deactivated at step 1238.

The “pic data” query is downloaded from the smart card, decoded and displayed on a screen before a security operator. In the preferred embodiment, a video camera is trained on the cardholder presenting the card. If the video image from the video camera matches the picture displayed by the processor derived from the “pic data” field, the security operator acknowledges the match through input on a keyboard keypad. Upon a positive input, the processor proceeds to the next query at step 1215. If not, the card is deactivated at step 1238. In a “retina data” query, at step 1216, data from a retina scanner connected as a field device to the processor is compared to the data in the data field. If a match is found within appropriate parameters at step 1217, then the processor proceeds to step 1218. If not, the card is deactivated at step 1238. At step 1218, a similar process takes place at “fingerprint data” query 1218. In this query, data from the “fingerprint data” field is compared to data from a similar fingerprint reader connected as a field device to the processor. The fingerprint reader scans the cardholder's finger and submits the data to the processor for comparison. Upon a favorable comparison in step 1219, the processor moves to step 1220. If there is not a favorable comparison, the card is deactivated at step 1238 and access is denied at step 1232. At step 1220, the cardholder is prompted to enter a password either through the keypad or the keyboard. Once entered, the data is compared to the data uploaded from the XML file. If a match is found at step 1221, then at step 1222, the location field of the XML file is updated. If not, the card is deactivated at step 1238. At step 1224, the XML data field “legacy data” is submitted to the processor for operation of various legacy applications. The processor then moves to step 1226 where a flag field is read. If the flag field contains data, the processor recognizes that one or more prior card readers were unable to communicate to the host computer via the network. A message is sent to the host computer, alerting it to an error condition of the prior processor and/or card readers. Then moving to step 1228, the processor updates the XML file and downloads it to the smart card. At step 1230, the processor sends a signal to the lock controller to grant access to the cardholder. At step 1234, the processor then updates the host network controller as to its status and that of the cardholder and goes back to sleep at step 1236. While asleep, the processor continually polls the reader for the presence of the smart card.

If any of queries 1208, 1210, 1212, 1214, 1216, 1218 or 1220 fails, the processor deactivates the smart card at step 1238 and denies access to the cardholder at step 1232. The processor then updates the host at step 1234 and goes to sleep at step 1236.

FIG. 7b shows a flow chart of the access request routine 700 executed by a controller in a preferred embodiment of the invention employing a USB class storage device as the electronic card 600. At step 705 an electronic access card is connected to a reader. In the preferred embodiment the electronic access card is configured with a bootstrap file system that is recognized by the SBC within the controller. In other embodiments, the controller incorporates a functioning operating system and so the sector is omitted. The controller uploads the bootstrap and operating system information from the electronic access card at step 710 and executes the operating system at step 713. Those skilled in the art will recognize that the SBC is capable of running many operating systems. One advantage of the invention is that if operating system is resident on the card, it can be varied from card to card without the necessity of being dependent on the type of SBC included in the controller. Hence, cardholders requiring more or less sophisticated operating systems or updated operating systems can be accommodated.

At step 714 the controller downloads the card ID from the identity data field stored on the electronic access card. The card ID is compared to a list of IDs on the exception list at step 715. The exception list contains a table including a list of card IDs and points to a set of files to be copied to the electronic access card with the card ID upon presentation to the reader. The exception list and associated files are either stored locally in memory at the controller or periodically downloaded by the controller from the local area network controller or wide area network controller during periods of operation.

If the card ID appears on the exception list then the controller copies the files from local memory to the memory onboard on the electronic access card at step 720. Encryption of the files in one embodiment takes place at this step. After copying the files, controller proceeds to step 725.

If the card ID is not on the exception list the controller proceeds directly to step 725.

At step 725 the controller downloads executable files and data files from the electronic access card. If encrypted, the executable files and data files are decrypted at step 727 using the decryption password stored in the identity table of the electronic access card. After decryption the executable files are loaded and run by the controller at step 730. If the data files include pointers, the controller is programmed to jump to the memory locations identified by the pointers, in a predetermined order, and execute the code at those locations. If the data files include program components, the applications requiring these components are instantiated.

The executable files can carry out a number of functions which are specific to the controller and the electronic access card. For example, in case of an administrator the executable files may include an editor which allows the administrator the ability to modify data stored in local memory of the controller, or modify information on the electronic access card. The executable files may also include applications which allow communication with a local area network controller or the wide area network controller. As another example in the case of a building manager, the executable files include applications which allow the building manager to access and control HVAC functions, parking functions or lighting functions of a building through function controller 420.

As another example in the case of a security manager, the executable files include interface applications to communicate with the legacy system 424 through function controller 420. Executable files also allow the positioning of video cameras and access to uploading or downloading recorded video information on stored video recorders 434. One skilled in the art will recognize that any number of executable files downloaded at step 730 are possible to control various discrete functions of the system and on electronic access cards connected to the system.

As yet another example, executable files could activate video outputs from CPU inputs and outputs from the single board computer to display a real time picture of the area to which the security manager is requesting entry before entry is granted. This feature is useful in such areas such as “hot containment” areas which an intruder or other hazardous situation has been identified. The security manager may review the situation on a display monitor physically placed by the reader before entering the area in which the hazard exists.

The controller then reports FASC information (if present) via the network at step 732, to allow access to government facilities as is required. At step 735 the controller loads the reader ID table from the electronic access card and compares the predetermined GUID for the particular controller to the list. If the GUID of the particular controller is not found on the ID list, a log signal is sent to local area controller at step 773. As an option, at step 774, the controller incapacitates the card so that further use is not allowed. Access is denied at step 775. If the GUID for the controller is found on the ID list then the controller proceeds to step 740 to query the cardholder or the electronic access card for secondary information. This step is optional. If the cardholder is queried for secondary information the secondary information usually includes a password like a personal identification number. In other embodiments the secondary information can be an answer to a question stored in the memory of the card. In these embodiments, the reader controller reads the memory of the card and may optionally translate the data into a display that is presented to the cardholder via a display screen. The cardholder is then queried for information which is entered through the keypad or touch screen. The question can of course be changed or rotated dependent on the electronic access card presented, the time of day, or geographic location of the card. The secondary information from the cardholder is then compared to the information stored on the electronic access card.

If the electronic access card itself is queried for secondary information, the secondary information can include biometric information. The biometric information is gathered at the reader site by the cardholder presenting a fingerprint, handprint or retina to the reader to be physically scanned and verified. At step 745 the biometric information is compared to that stored in the electronic access card. In this embodiment, those skilled in the art will recognize that neither the data from the biometric scan nor the electronic access card need be stored indefinitely at the controller for each cardholder. Therefore, memory at the controller only need be supplied in sufficient quantity to store two sets of the information for comparison, one set from the biometric reader and one set from the electronic access card. If the secondary information is not valid then the controller reports the status to the local area network at step 773 and access is denied at step 775. If the secondary information is valid the controller moves to step 750.

At step 750, the controller compares its GUID to the tracking list of reader GUIDs contained in the tracking field of the electronic access card and updates it if required. This field is used to implement the “anti-pass back” feature of the invention. This feature will be discussed in more detail later in this disclosure.

Continuing with FIG. 7b, the controller determines if its GUID is properly included on the tracking list stack. If it is not, the status is reported to the local area network controller, step 773 and access is denied at step 775. If it is, the controller moves to step 755 and reports an “access granted” condition to the local area network controller. In another embodiment, the log may be maintained within local memory at the controller. At step 760, the exception list in the electronic access card is updated at step 760. At step 765, the stack and the update tracking list is updated. At step 770, a “grant access” condition is declared and displayed for the cardholder. Simultaneously, signals are sent to a lock controller to grant access to the secured area.

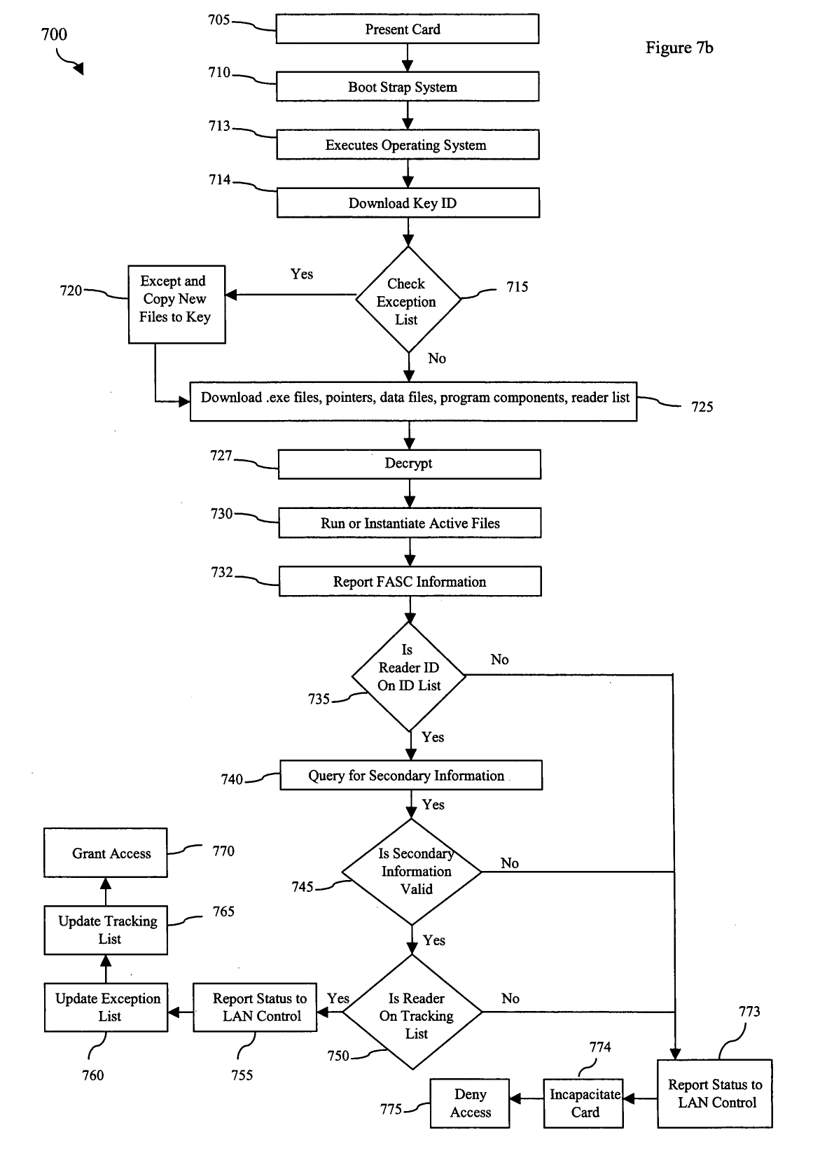

FIG. 8 shows the steps that the controller goes through before and after executing access request routine 800.

The controller is found in a “sleep” state 805 waiting for presentation of an electronic access card. In the preferred embodiment where no operating system is present before presentation of the electronic access card, the only activity taking place in the controller is monitoring the reader for presentation of an electronic access card. In embodiments where an operating system is present on the controller, various background activities including polling the reader for the presence of an electronic access card are occurring. These activities can include updating of the exception list or downloading other information from the local area network controller or the wide area network controller.

At step 810, an access request is made and the access request routine is run. After its completion, the controller moves to step 815 where it requests access to and downloads the master exception list from the local area network controller or the wide area network controller.

At step 820, the controller uploads program components, data files and executable files received from the electronic access card to the local area network controller. Similarly, at step 825, the exception list included in the data field of the electronic access card is uploaded to the network. At step 830, all executable applications are terminated and at step 835, the controller deletes all data files and executable files and overwrites them before returning to idle state 805.

The “anti-pass back” feature of the invention will now be described. The purpose of the anti-pass back feature is to stop a cardholder from entering a secured area and then handing his card back to someone to enter the same area. To implement the anti-pass back feature of the invention, readers adjacent turnstiles are designated as “in” readers for entry into a designated area and “out” readers for logging out of a controlled area. Each controlled area is designated a numeric value. In the preferred embodiment, the GUID of each controller may be used as a designated value for each controlled area. The numeric values of the areas increase as the cardholder passes from the exterior of the controlled area to the interior through various controlled areas. When a cardholder attempts to use an “in” reader, the system checks to make sure that the designated number of the controlled area that the cardholder is entering is numerically higher than the designated number of the controlled area that the cardholder is leaving. If the designated number of the controlled area is the same or lower, the system reports and “anti-pass back error” message and entry is denied. If the area that the cardholder is attempting to enter is indeed higher than the designated value of the area that the cardholder is currently logged into, then access is granted. Upon exiting the cardholder must traverse a series of “out” readers. When the cardholder attempts to use an “out” reader, the system checks to make sure that the designated number of the controlled area that the cardholder is leaving is numerically lower than the designated number of the controlled area that the cardholder is entering. If the designated number of the controlled area is the same or greater, the system reports an “anti-pass back” error message and exit is denied. If the area that the cardholder is attempting to enter is lower than the designated value of the area that the cardholder is currently logged into, then exit is granted.

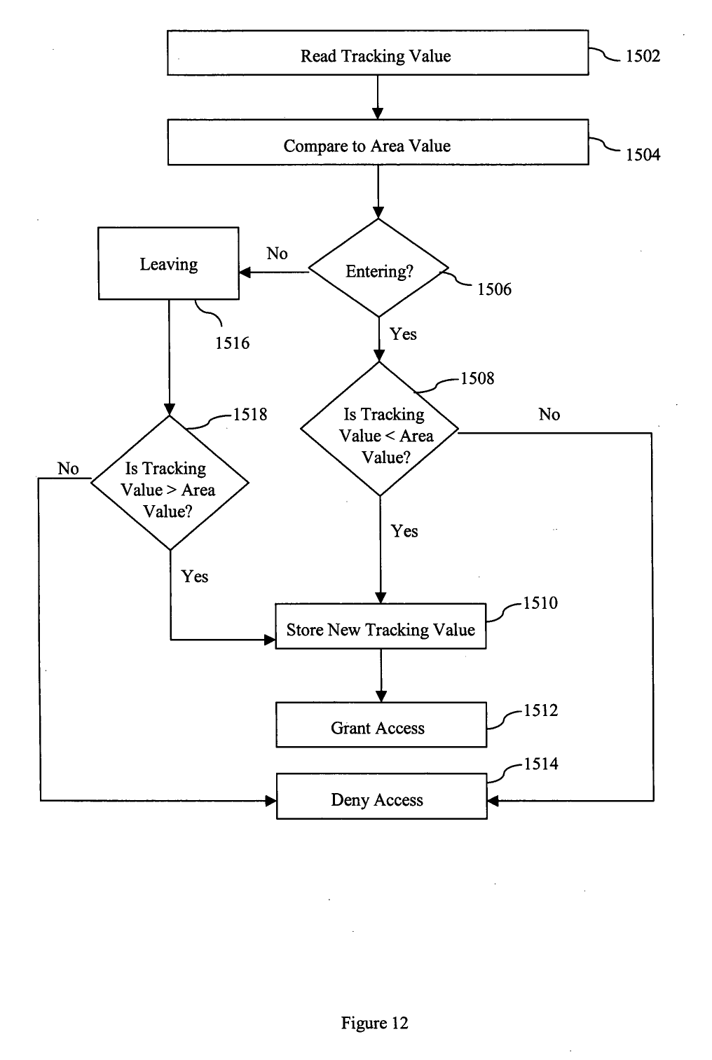

Referring to FIG. 12, a flow chart of the anti-pass back feature of this preferred embodiment is described. At step 1502, tracking value is read from a smart card presented to a reader connected to the controller. The tracking value is compared to the area value that the cardholder wishes to enter stored in memory of the controller at step 1504. If the reader to which the cardholder is presenting his card has been designated as an “in” reader, then it is determined that the cardholder is entering the next area at step 1506 and step 1508 is executed. If the tracking value is less than the area value that the cardholder wishes to enter at step 1508, then the area value of the area that the cardholder wishes to enter is stored as a new tracking value on the card at step 1510 and access is granted to the new area at step 1512. If the tracking value is greater than the new area value, then access is denied at step 1514.

Alternatively, if it is determined that the cardholder is not entering the area at step 1506, then it is assumed that the cardholder is leaving the area at step 1516 and step 1518 is executed. In this case, if the tracking value stored in the card is greater than the new area value, then the area value of the new area stored in the card at step 1510 and access is granted at step 1512. If the tracking value is less than the area value at step 1518, then access is denied at step 1514.

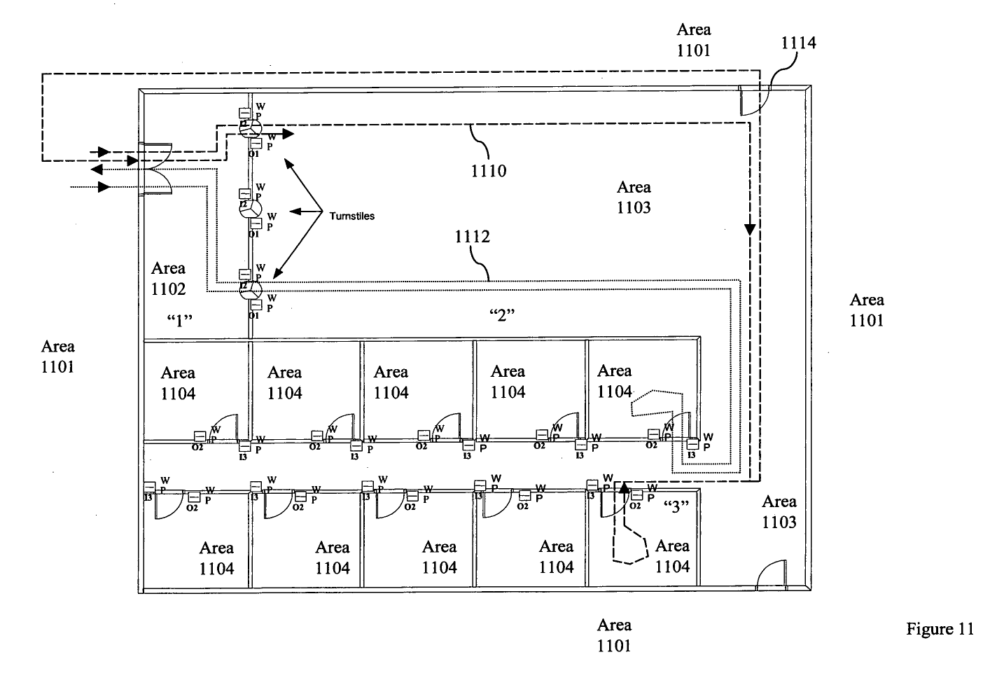

Referring then to FIG. 11, an “anti-pass back” example is described. FIG. 11 illustrates a plan view of a building that is configured for anti-pass back according to the preferred embodiment. Area 1101 includes the exterior of the building and an interior entry way. Area 1102 is fitted with three “in” readers designated “I2” at the portals between area 1102 and area 1103. Area 1103 is fitted with three “out” readers at the portals between area 1103 and area 1102. Area 1102 is also fitted with ten “in” readers, “I3”, at the interfaces between areas 1103 and areas 1104. Each area 1104 is fitted with an “out” reader “O2” at the portals between each area 1104 and area 1103. Numeric values are assigned in this example for area 1102 as numeric value “1”. Area 1103 is assigned a numeric value of “2”, and area 1104 is assigned a numeric vale of “3”. A cardholder taking path 1110 proceeds through the turnstile presenting his card at “I2” in area 1102. Since the numeric value of area 1103 “2” is greater than the numeric value of area 1102, “1”, access is granted by the controller and allows passage of the cardholder. The tracking value in the card is changed from numeric “1” to numeric “2” by the controller.

Proceeding on path 1110, the cardholder presents his card at entry portal I3 in area 1102 requesting entry into area 1104. The controller compares the tracking number “2” currently stored in the card with the area 1104 numeric value “3” and determines that the tracking value is indeed less than the area value and allows entry. Continuing on path 1110, the cardholder, upon exiting area 1104, presents his card at O2 in area 1104. The stored value in the card (now “3”) is compared to the value “2”. Since the cardholder is leaving a controlled area, the tracking value is greater than the area value and exit is allowed. The controller changes the tracking value in the card to “2”. However, on path 1110, the cardholder exits through controlled area 1114 without presenting his card to a controller and attempts to return through by presenting his card at “I2” in area 1101. The tracking value from the card is now “2”. Upon presenting his card at “I2”, the tracking value “2” is not less than then area value “1” of area 1102. Therefore, entry is denied and pass back is defeated.

Continuing with FIG. 11, an alternate path 1112 is described. The cardholder presents his card at reader 12 in area 1102. The controller compares the numeric value “1” and the numeric value “2” and allows entry since the tracking value is less than the area value. The tracking value of the card is then replaced with a “2”. Continuing along path 1112, the cardholder presents his card at reader I3 to enter area 1104. The controller compares tracking value “2” to the area 1104 value “3” and allows entry since the tracking value is less than the area value.

Upon exit of area 1104, the controller compares the stored value “3” on the card to the area value “2” of area 1103 and allows exit since the tracking value is greater than the area value. In this example, however, the cardholder elects to proceed back to area 1101 by presenting his card to an “out” reader in area 1103. The controller compares tracking value “2” to area value “1” of area 1102 and allows exit. The value of area “1” is again stored in the card.

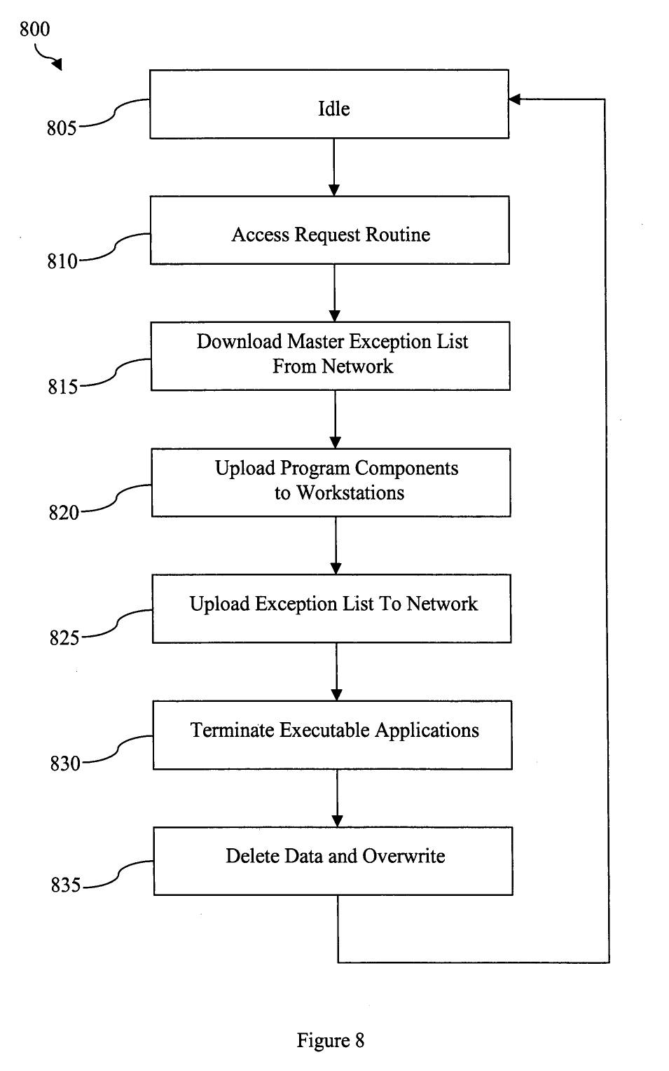

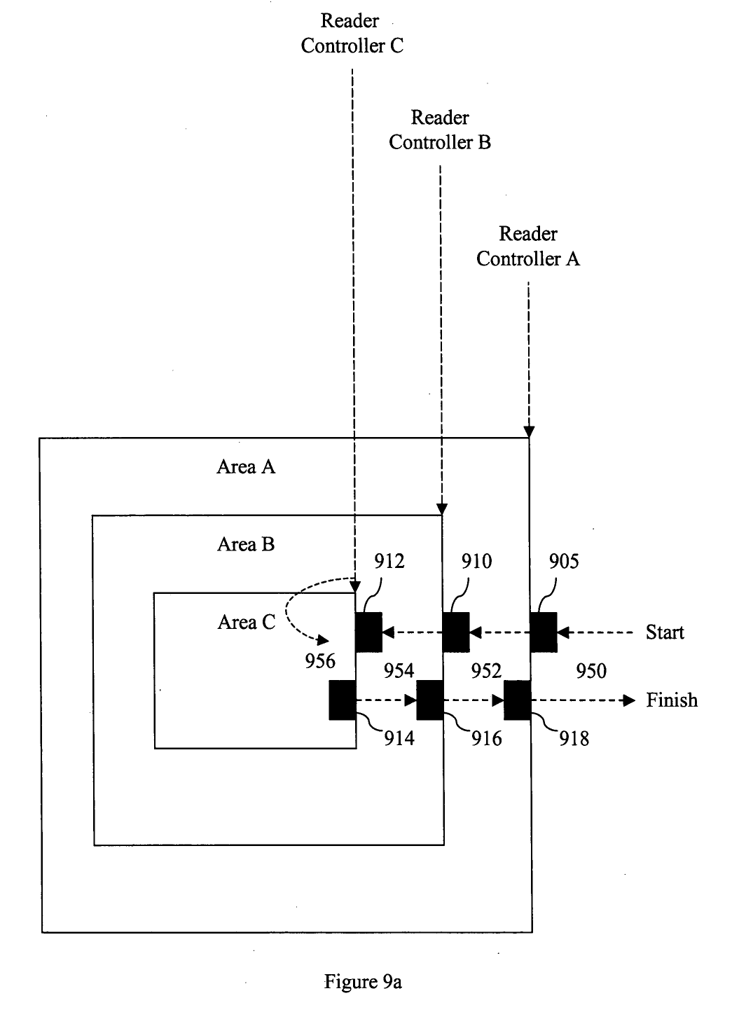

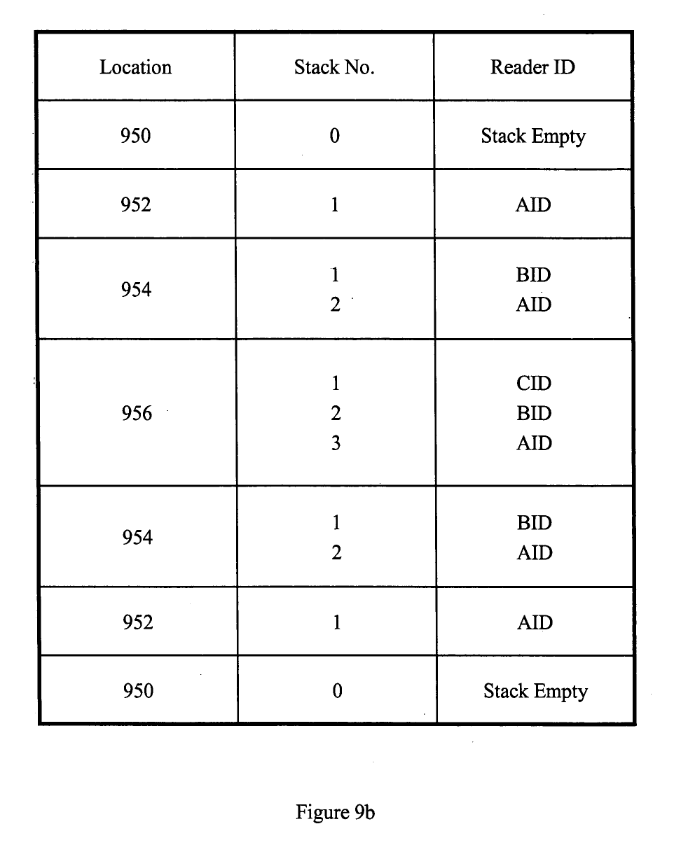

In an alternate embodiment of the “anti-pass back” concept, a “last in first out” stack is employed to store reader GUIDs as any indication of the location of the cardholder. FIGS. 9a and 9b illustrate the concept. FIG. 9a represents a schematic diagram of the path a cardholder would take through three separate secured locations within a building, Area A, Area B and Area C. FIG. 9b represents the LIFO stack maintained in the tracking field of the electronic access card during the trip.

At the beginning of the trip, the stack in the tracking field of the electronic access card is empty while the cardholder is at location 950. Upon a request for access to Area A, location 952, the electronic access card is presented to the exterior reader 905 of controller A. If access is granted, the cardholder is allowed into location 952. The tracking field reflects a single stack number and the reader GUID for controller A. Upon presentation of the electronic access card to the exterior reader connected to controller B, and if access is granted, the individual moves to location 954. The GUID for controller B is “pushed” onto the stack. The stack number reflects two stack entries with the most recent stack entry being the GUID for controller B. Upon moving to Area C, location 956, the electronic access card is presented to the exterior reader 912 of controller C. If granted, the stack in the tracking field reflects three entries with the topmost entries being the GUID for controller C.

Upon exiting Area C, location 956, the electronic access card is presented to the interior reader of controller C at 914. The GUID for controller C is “popped” off of the LIFO stack in the tracking field reflecting that the cardholder is present in Area B, location 954. Upon exit of Area B, the electronic access card is presented to the interior reader connected to the controller B at 916. If exit is allowed, then the GUID for controller B is “popped” off the stack, showing that the card is present in area 952, leaving the only entry in the stack as the GUID for controller A. Upon exit of Area A, the last entry of the stack is “popped” off, leaving the stack empty and indicating that the electronic access card is present in location 950.

A second preferred embodiment of the tracking list of the electronic access card is a “first in first out” (or FIFO) stack of reader GUIDs of the electronic access card has been in contact with. FIGS. 9a and 9c illustrate the concept. FIG. 9c represents the FIFO stack maintained in the tracking field of the electronic access card during the trip.

At the beginning of the trip, the stack and the tracking field and electronic access card is empty while the cardholder is at location 950. Upon a request for access to area A, location 952, the electronic access card is presented to the exterior reader 905 or controller A. If access is granted, the cardholder is allowed into location 952. The tracking field reflects a single stack number and the reader GUID for the controller A. Upon presentation of the electronic access card to exterior reader 910 connected to controller B, and if access is granted, the individual moves to location 954. The GUID for controller B is “pushed” onto the stack. The stack number reflects two stack entries with the most recent stack entry being the GUID for controller B. Upon moving to area C, location 956, the electronic access card is presented to the exterior reader 912 of controller C. If granted, the stack in the tracking field reflects three entries with the topmost entries being the GUID for controller C.

Upon exiting area C, location 956, the electronic access card is presented to the interior reader of controller C at 914. The GUID for controller C is then “pushed” onto the FIFO stack in the tracking field reflecting that the cardholder is present in area B, location 954. Upon exit of area B, the electronic access card is presented to the interior reader connected to the reader controller B at 916. If exit is allowed, the GUID for controller B is “pushed” onto the stack. Upon exit of area A, the last entry of the stack is “pushed” onto the stack, indicating the electronic access card is again present in location 950. Those skilled in the art will recognize that the FIFO stack of the preferred embodiment of the invention must be of limited memory size in order for the electronic access key to function. In the preferred embodiment, the FIFO stack is limited to 100 entries of GUID data or approximately 1600 bytes. However, in other embodiments, this number can be increased or decreased.

If the electronic access card is presented to any interior or exterior reader connected to a controller out of sequence, then access or exit is not allowed. This feature of the invention accomplishes two goals. First, anti-pass back is achieved because if the card reader is not presented in sequence, the stack entry can be examined and entry or access can be denied to an unauthorized cardholder. Also, location tracking can be accomplished without the need for network communication between controllers.

Those skilled in the art will recognize that, among other advantages, the invention provides a method of replacing a large database of cardholder IDs with a distributed storage of allowed GUIDs of controllers, thereby reducing the storage and speed requirements on any single server. Further, since the identification data is distributed, the risk associated with storage of the large database of cardholder IDs is drastically reduced.

1. A system for secure access control comprising:
a controller having a unique identifier;
a controllable access portal in communication with the controller;
a first reader in communication with the controller;
a data card, removably connectable to the reader, for storing the unique identifier list; and,
the controller programmed to upload the unique identifier list from the data card, compare the unique identifier to the unique identifier list and to open the controllable access portal if the unique identifier is in the unique identifier list.

2. The system of claim 1 wherein the data card further stores a first operating system and
the controller is further programmed to upload and implement the first operating system upon connection to the data card.

3. The system of claim 2 further comprising:
a second data card storing a second operating system;
the controller programmed to upload and implement the second operating system upon connection to the second data card.

4. The system of claim 2 wherein the first operating system and second operating system are different.

5. The system of claim 1 wherein the data card further stores a bootstrap segment and
the controller is further programmed to upload the bootstrap segment and boot an operating system upon connection to the data card.

6. The system of claim 2 wherein the first operating system is stored in the data card.

7. The system of claim 2 wherein the first operating system is stored in a memory connected to the controller.

8. The system of claim 1 wherein the data card further stores a FASC data field and the controller is further programmed to upload the FASC data field upon connection to the data card.

9. The system of claim 1 wherein the data card further stores an executable file and the controller is further programmed to upload the executable file upon connection to the data card.

10. The system of claim 1 wherein the data card further stores a pointer file containing at least one pointer and the controller is further programmed to execute a code segment stored in a memory attached to the controller located at a location in the memory corresponding to the at least one pointer.

11. The system of claim 1 wherein the data card further stores identity data and the controller is further programmed to:
query a cardholder for the response data;
compare the response data to the identity data; and,
open the controllable access portal upon a match between the response data and the identity data.

12. The system of claim 1 wherein the data card further stores a program component and the controller is further programmed to:
load the program component; and
run the program component.

13. The system of claim 1 wherein the data card further stores a card ID and the controller is further programmed to:
compare the card ID to an exception list; and
if the card ID is found on the exception list, then alter a data field on the data card.

14. The system of claim 1 wherein the data card further stores a tracking field and the controller is further programmed to update the tracking field with the unique identifier.

15. The system of claim 15 wherein the tracking field contains a stack of data related to a physical location of the data card.

16. The system of claim 14 wherein a second reader in communication with the controller;
the first reader in a first controlled physical area with a first designated area number stored in a memory of the controller;
the second reader in a second controlled physical area with a second designation and a number stored in the memory of the controller;
the data card storing a tracking number;
the controller further programmed to read the tracking number from the data card upon presentation of the data card at the first reader;
compare the tracking number to the second designation area number;
if the second designated area number is greater than the tracking number, then activating the controllable access portal to grant access and storing the second designated area number in the data card as the tracking number and if the second designated area number is less than the tracking umber, then denying access.

17. The system of claim 16 wherein the controller is further programmed to:
read the tracking number from the data car upon presentation of the data card at the second reader;
compare the tracking number of the first designated area number;]
if the first designated area number is less than the tracking number, then activating the controllable access portal to grant access and storing the first designated area number in the data card as the tracking number; and
if the first designated area number is greater than the tracking number, then denying access.

18. The system of claim 1 wherein the data card further stores function controller data and the controller is further programmed, to upload the function controller data to a function controller.

19. The system of claim 13 wherein the function controller is programmed to use the function control data to operate one of the group of:
a legacy system, a HVAC system, a lighting system, a parking system and a video/audio system.

20. The system of claim 1 wherein the controller is further programmed to establish communication with a local area controller and upload a log entry to the local area controller.

21. The system of claim 1 wherein the controller is further programmed to establish communication with a local area network and establish communication with a wide area network.

22. The system of claim 21 wherein the controller is further programmed to move a data set related to the data card to the wide area network.

23. A system for controlling access to controlled areas comprising:
a first programmable controller having a first unique identifier and a first key access connector;
a first controllable lock operatively connected to the first controller;
a second programmable controller having a second unique identifier and a second key access connector;
a second controllable lock operatively connected to the second controller;
a first access key removably connectable to the first key access connector and the second key access connector and having a first readable memory programmed with the first unique identifier and the second unique identifier and wherein:
the first programmable controller is programmed to:
read the first readable memory and identify the first unique identifier; and
open the controllable lock to allow access to the controlled areas upon identification of the first unique identifier.

24. The system of claim 23 wherein the first readable memory is a nonvolatile memory.

25. The system of claim 23 wherein the first access key is one of the group of a USB device, a SD device and a smart card device.

26. The system of claim 23 wherein the first readable memory is further programmed with a data set in a data field and the first programmable controller is further programmed to alter the data set in the data field.

27. The system of claim 26 wherein the data set contains the second unique identifier.

28. The system of claim 26 wherein the data set stores data related to the physical presence of the first access key in the controlled areas.

29. The system of claim 28 wherein the data set is arranged in a LIFO stack.

30. The system of claim 28 wherein the data set is arranged in a FIFO stack.

31. The system of claim 23 further comprising a second access key removably connectable to the first key access connector and the second key access connector and having a second readable memory programmed with the second unique identifier and wherein the first controller is programmed to:
read the second readable memory and identify the absence of the first unique identifier; and
deny access to the controlled areas upon recognition of the absence of the first unique identifier.

32. The system of claim 31 wherein:
a first operating system is stored in the first readable memory;
a second operating system is stored in the second readable memory;
the first programmable controller is programmed to:
upload and run the first operating system upon connection of the first access key to the first key access connector; and
upload and run the second operating system upon connection of the second access key to the first key access connector.

33. The system of claim 32 wherein the first operating system and the second operating system are different.

34. The system of claim 31 wherein the first controller is further programmed to record the denial of access to the controlled areas.

35. The system of claim 31 wherein the first controller is further programmed to incapacitate the second access key.

36. The system of claim 23 further comprising:
a biometric reader capable of producing a first data file related to a human physical characteristic, connected to the first programmable controller;
the first access key having the first readable memory programmed with a second data file related to the human physical characteristic; and
the first programmable controller further programmed to compare the first data file related to the human physical characteristic to the second data file related to the human physical characteristic and determine if a match condition exists.

37. The system of claim 23 further comprising:
a data entry device, connected to the first programmable controller, for entry of data by a keyholder;
a communication device, connected to the first programmable controller for communication of request data to the keyholder; and
the first programmable controller further programmed to:
communicate the request data to the keyholder;
receive response data from the data entry device;
compare the response data to the request data to form a decision; and
respond to the decision.

38. The system of claim 37 wherein the request data is stored in the first readable memory.

39. The system of claim 23 wherein the first readable memory is programmed with a bootstrap program and the first programmable controller is further programmed to boot from the bootstrap program.

40. The system of claim 23 wherein the first programmable controller is a single board computer.

41. The system of claim 23 wherein the first unique identifier is a GUID.

42. A method of verifying the access authorization of an access card comprising:
presenting the access card to a reader connected to a controller having a unique GUID;
uploading a GUID list from the access card to the controller;
receiving a decision from the controller as to the presence of the GUID on the GUID list;
not blocking access authorization if the GUID is on the GUID list; and
blocking access authorization if the GUID is not on the GUID list.

43. The method of claim 42 comprising the further steps of:
downloading a first data file from the access card to the controller;
downloading a unique key identifier from the access card to the controller;
receiving a decision from the controller as to the presence of the unique key identifier on an exception list; and
uploading a second data file to the access card from the controller if the unique identifier is on the exception list.

44. The method of claim 42 further comprising the steps of:
receiving a request for secondary information from the controller;
returning the secondary information from the access card;
receiving a decision from the controller as to the validity of the secondary information;
not blocking access if the secondary information is valid; and
blocking access if the secondary information is not valid.

45. The method of claim 44 wherein the secondary information is one of the list of fingerprint data, facial data, encryption data, question and answer data and FASC data.

46. The method of claim 42 wherein the first data file is one from the list of an executable file, a pointer file, a program component, a reader list, a bootstrap program, a FASC data field, a file of function control data, an exception list and a tracking file.

47. The method of claim 46 comprising the further step of:
implementing the first data file.

48. The method of claim 42 further comprising the steps of:
downloading a tracking list from the access card;
receiving a decision from the controller as to the presence of the GUID on the tracking list;
not blocking access if the GUID is not on the tracking list; and
blocking access if the GUID is on the tracking list.

49. The method of claim 48 further comprising the steps of:
not blocking access if the GUID is on the tracking list;
blocking access if the GUID is not on the tracking list.

50. The method of claim 42 further comprising the step of:
reporting an access condition to a LAN controller.

51. The method of claim 42 further comprising the step of:
updating an exception list from a LAN controller.

52. The method of claim 42 further comprising the step of:
decrypting the first data file.

53. The method of claim 42 further comprising the step of:
encrypting the first data file.
